(19) United States
(12) Patent Application Publication
(10) Pub. No.: US 2011/0070899 A1
(43) Pub. Date: Mar. 24, 2011

(54) COMMUNICATION TERMINAL AND LOCATION INFORMATION NOTIFICATION METHOD

(75) Inventors: Hidenori TONOSAKI, Kawasaki (JP); Hideki Arata, Ishikari (JP); Naotaka Obara, Kawasaki (JP); Yoshinori Arihara, Kawasaki (JP)

(73) Assignee: FUJITSU LIMITED, Kawasaki-shi (JP)

(21) Appl. No.: 12/728,430

(22) Filed: Mar. 22, 2010

(30) Foreign Application Priority Data
Mar. 24, 2009 (JP) 2009-072276

(51) Int. Cl. H04W 4/02

(52) U.S. Cl. 455/456.2

(57) ABSTRACT

A location information notification method for transmitting location information regarding a communication terminal, the location information notification method includes receiving a signal indicating a request for the communication terminal to provide location information, determining whether a transfer setting for the communication terminal has been performed, and causing a condition restraining transmission of the location information from the communication terminal in response to the received signal when the determining determines the transfer setting has been performed. The transfer setting indicates that communications to the communication terminal are being transferred to another communication terminal.

### CROSS-REFERENCE TO RELATED APPLICATIONS

This application is based upon and claims the benefit of priority of the prior Japanese Patent Application No. 2009-72276, filed on Mar. 24, 2009, the entire contents of which are incorporated herein by reference.

### FIELD

Embodiments described herein relate to a communication terminal which notifies location information and a location information notification method.

### BACKGROUND

A recent radio communication terminal (e.g., a mobile phone) uses a high-precision positioning function of a Global Positioning System (GPS) to obtain location information regarding another terminal. Thus, it is possible to confirm the location of a user of the radio communication terminal.

For example, when confirmation of the location of a user of a radio communication terminal, the radio communication terminal is designated and location information is requested via a network to obtain the location information of the radio communication terminal.

However, the case is assumed where a user of a radio communication terminal (referred to as a terminal A1) performs transfer setting on the terminal A1 causing communications to the terminal A1 to be transferred to a another communication terminal (referred to as a terminal A2) at a location different from the location of the terminal A1. In this case, when the terminal A1 returns location information, the location information is related to terminal A1 instead of the terminal A2. As such, the location of the user cannot be properly confirmed.

For example, Japanese Laid-open Patent Publication No. 06-188986 discloses a technology in which an exchange causes area information regarding a location, to which a mobile terminal has been moved, to be displayed on a display or the like.

However, when an apparatus on a network side manages and notifies location information regarding a radio communication terminal, for example, the apparatus may be provided for every communication common carrier, resulting in an increase in cost.

### SUMMARY

According to an aspect of the invention, a location information notification method for transmitting location information is provided. The location information notification method includes receiving a signal indicating a request for the communication terminal to provide location information, determining whether a transfer setting for the communication terminal has been performed, and causing a condition restraining transmission of the location information from the communication terminal in response to the received signal when the determining determines the transfer setting has been performed. The transfer setting indicates that communications to the communication terminal are being transferred to another communication terminal.

According to an aspect of the invention, a location information notification method includes storing certain information for responding to a received signal requesting location information of the communication terminal when a transfer setting has been performed on the communication terminal, and transmitting the certain information to a source of the received signal without transmitting the location information regarding the communication terminal when the transfer setting has been performed on the communication terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a communication system to which an embodiment of the invention is applied;

FIG. 2 illustrates an operation of the present embodiment;

FIG. 3 illustrates an example of device configuration of a radio communication terminal that is used in the present embodiment;

FIG. 4 is a functional block diagram illustrating functions of a control unit 13 in FIG. 3;

FIG. 5 illustrates an example of a data structure of data included in a location information request that is used in the present embodiment;

FIG. 6 illustrates an example of a data structure of data included in a response signal to the location information request that is used in the present embodiment;

FIG. 7 is a flow chart illustrating a flow in which a radio communication terminal creates and transmits a location information request for requesting another radio communication terminal to provide location information;

FIG. 8 is a flow chart illustrating a flow in which a radio communication terminal receives a location information request transmitted from another radio communication terminal and transmits a response to the location information request;

FIG. 9 is a flow chart illustrating a flow in which a radio communication terminal receives, from another radio communication terminal, a response to a location information request and obtains location information or transfer destination information;

FIG. 10 illustrates a display example of location information;

FIG. 11 is a flow chart illustrating a flow in which each radio communication terminal selects one piece of location information as location information regarding the radio communication terminal from location information DB; and

FIG. 12 is a flow chart illustrating a flow in which a radio communication terminal receives a location information request transmitted from another radio communication terminal and transmits a response to the location information request.

### DESCRIPTION OF EMBODIMENTS

The following will describe in detail an embodiment of the invention.

### (1) Communication System

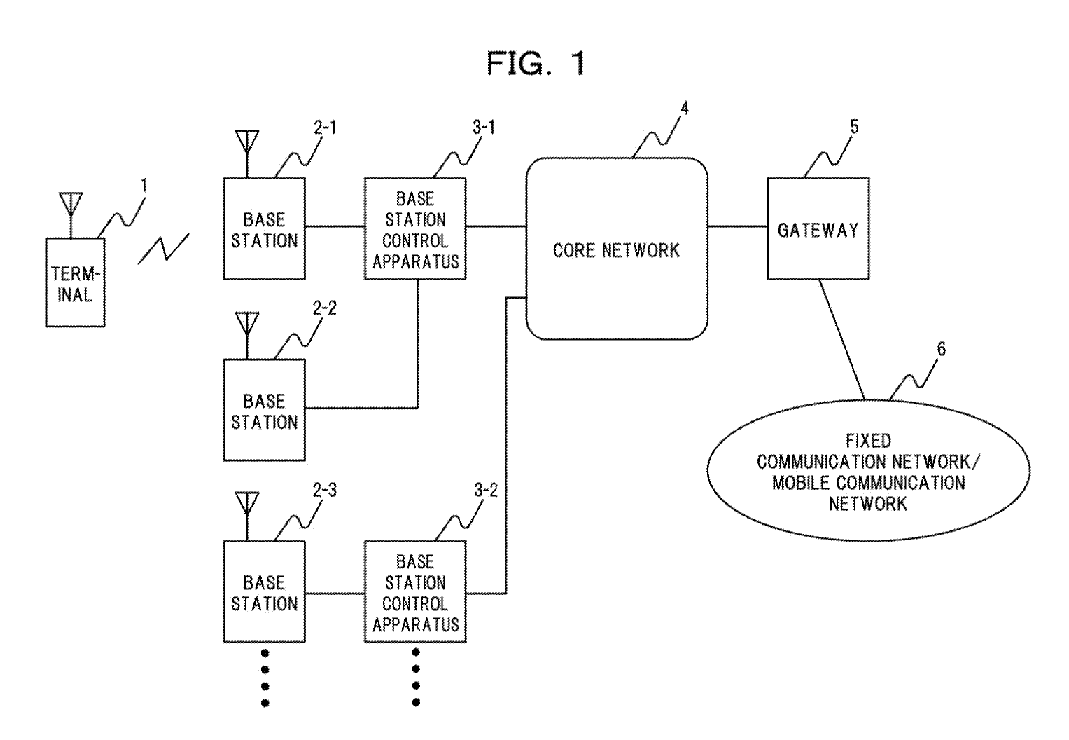

FIG. 1 illustrates an example of a communication system to which an embodiment of the invention is applied.

In FIG. 1, the reference numeral 1 indicates a radio communication terminal (e.g., a mobile phone); the reference numerals 2-1, 2-2, and 2-3 indicate radio base stations; the reference numerals 3-1 and 3-2 indicate base station control apparatuses; the reference numeral 4 indicates a core network; the reference numeral 5 indicates a gateway apparatus, and the reference numeral 6 indicates a fixed communication network/mobile communication network. The core network 4 includes, for example, a subscriber exchange and a transit exchange.

For example, the radio communication terminal 1 performs communication via the radio base station 2-1, the base station control apparatus 3-1, and the core network 4 with another radio communication terminal that is connected to a communication network to which the radio communication terminal 1 is connected. In addition, the communication terminal 1 is capable of performing communication via the gateway apparatus 5 with a radio communication terminal or a fixed communication terminal that is connected to another radio communication network or the fixed communication network.

### (2) Outline of an Embodiment

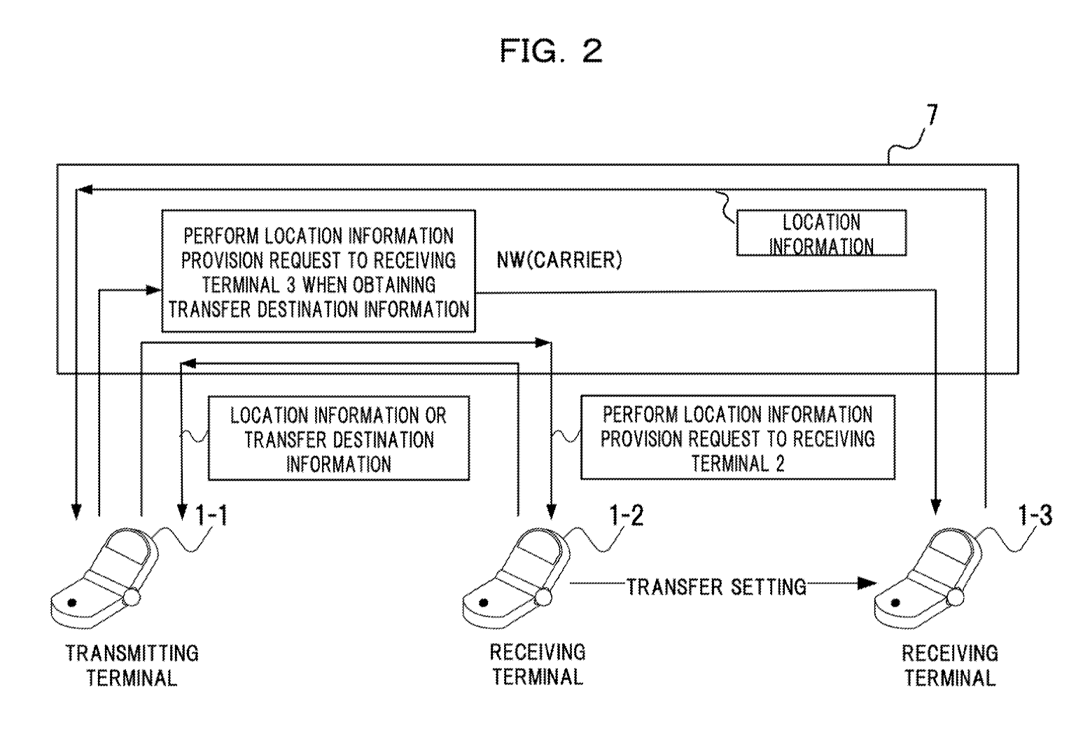

FIG. 2 illustrates an operation outline of an embodiment.

In FIG. 2, terminals 1-1, 1-2, and 1-3 are radio communication terminals, and the reference numeral 7 indicates a network (NW). For example, the NW 7 includes the radio base stations 2-1, 2-2, 2-3, the base station control apparatuses 3-1, 3-2, the core network 4, and the gateway apparatus 5 in FIG. 1, another fixed communication network/mobile communication network, and the like.

For example, an embodiment will be described using an example where a user of the terminal 1-1 desires confirmation of the location of a user of the terminal 1-2.

The terminal 1-1 transmits a signal requesting that terminal 1-2 provide location information regarding the terminal 1-2 via the NW 7. Hereinafter, the signal requesting the location information is referred to as a location information request.

Upon receipt of the location information request transmitted from the terminal 1-1, the terminal 1-2 determines whether or not a transfer setting of an incoming call to the terminal 1-2 has been performed.

When the terminal 1-2 determines that the transfer setting of an incoming call to the terminal 1-2 has not been performed, the terminal 1-2 transmits location information regarding the terminal 1-2, which is measured by using a Global Positioning System (GPS), to the terminal 1-1 via the NW 7.

Thus, the terminal 1-1 may obtain the location information regarding the terminal 1-2.

On the other hand, when the terminal 1-2 determines that the transfer setting of an incoming call to the terminal 1-2 has been performed, the terminal 1-2 does not transmit the location information regarding the terminal 1-2. Rather, the terminal 1-2 transmits information (hereinafter, referred to as transfer destination information) regarding a terminal that is a transfer destination, to the terminal 1-1 via the NW 7. For example, in FIG. 2, the terminal 1-3 is the transfer destination.

Upon receipt of the transfer destination information transmitted from the terminal 1-2, the terminal 1-1 transmits a location information request for requesting the terminal 1-3 to provide location information regarding the terminal 1-3, to the terminal 1-1 via the NW 7 based on the transfer destination information.

Upon receipt of the location information request transmitted from the terminal 1-1, the terminal 1-3 transmits location information regarding the terminal 1-3 that is measured by using the GPS, to the terminal 1-1 via the NW 7.

The terminal 1-1 obtains the location information regarding the terminal 1-3 that is transmitted from the terminal 1-3.

As described above, when the transfer setting of an incoming call to the terminal 1-2 has been performed, the terminal 1-1 may obtain the location information regarding the terminal 1-3 that is the transfer destination, not the location information regarding the terminal 1-2. In other words, when the transfer setting of an incoming call to the terminal 1-2 has been performed, the terminal 1-2 is restrained from transmitting the location information regarding the terminal 1-2 to the terminal 1-1.

Thus, for example, when the user of the terminal 1-2 carries the terminal 1-3 that is the transfer destination for an incoming call to the terminal 1-2, the user of the terminal 1-1 may confirm the location of the user of the terminal 1-2, which is the location of the terminal 1-3.

It is noted that terminal 1-3 may be set such that an incoming call to the terminal 1-3 is transferred to yet another communication terminal. In this case, the terminal 1-3 does not transmit the location information regarding the terminal 1-3 and may transmit transfer destination information to the terminal 1-1.

Moreover, the present embodiment may be implemented without addition to and/or modification of an apparatus on the network side. Thus, the present embodiment may be applicable to communication terminals of domestic and foreign carriers.

### (3) Example of a Configuration of a Radio Communication Terminal

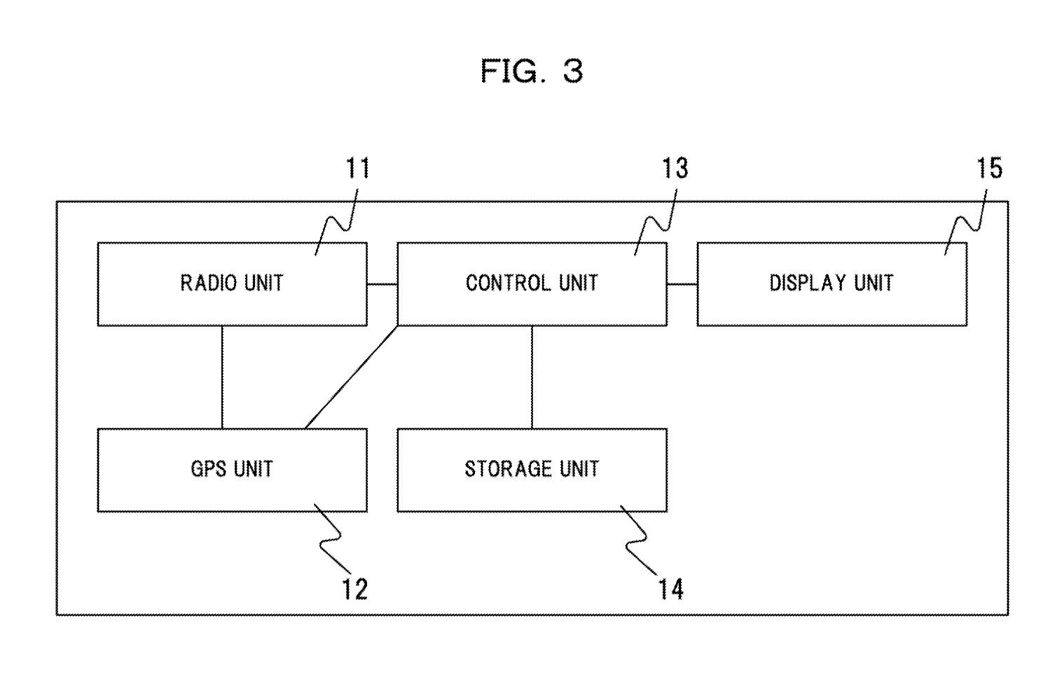

FIG. 3 illustrates an example of a device configuration of a radio communication terminal that is used in an embodiment.

In FIG. 3, the reference numeral 11 indicates a radio unit; the reference numeral 12 indicates a GPS unit; the reference numeral 13 indicates a control unit; the reference numeral 14 indicates a storage unit; and the reference numeral 15 indicates a display unit.

The radio unit 11 transmits and receives radio signals to and from a radio base station.

The GPS unit 12 receives a GPS signal transmitted from a GPS satellite, which is not illustrated, and obtains location information, such as latitude and longitude, regarding the radio communication terminal based on positioning data obtained by demodulation. In addition, the GPS unit 12 may obtain the location information regarding the radio communication terminal from the network.

The control unit 13 writes and reads information into and from the storage unit 14. Later-described functions of the control unit 13 are implemented by a processor or CPU, for example.

The storage unit 14 includes a memory (hereinafter, referred to as location information DB) for storing location information regarding the radio communication terminal that is obtained by the GPS unit 12 and certain location information that is set by the user. In addition, the storage unit 14 includes a memory (hereinafter, referred to as an address book) for storing information, such as the name, the phone number, and the E-mail address of a user of another communication terminal, such that they are associated with each other. Further, the storage unit 14 includes a memory (hereinafter, referred to as a transfer setting storage unit) for, when transfer setting of an incoming call to the radio communication terminal is performed, storing: information, such as a transfer setting flag, indicating that the transfer setting has been performed; and transfer destination information such as the phone number of a transfer destination.

The display unit 15 is, for example, a display, and displays information in accordance with control of the control unit 13.

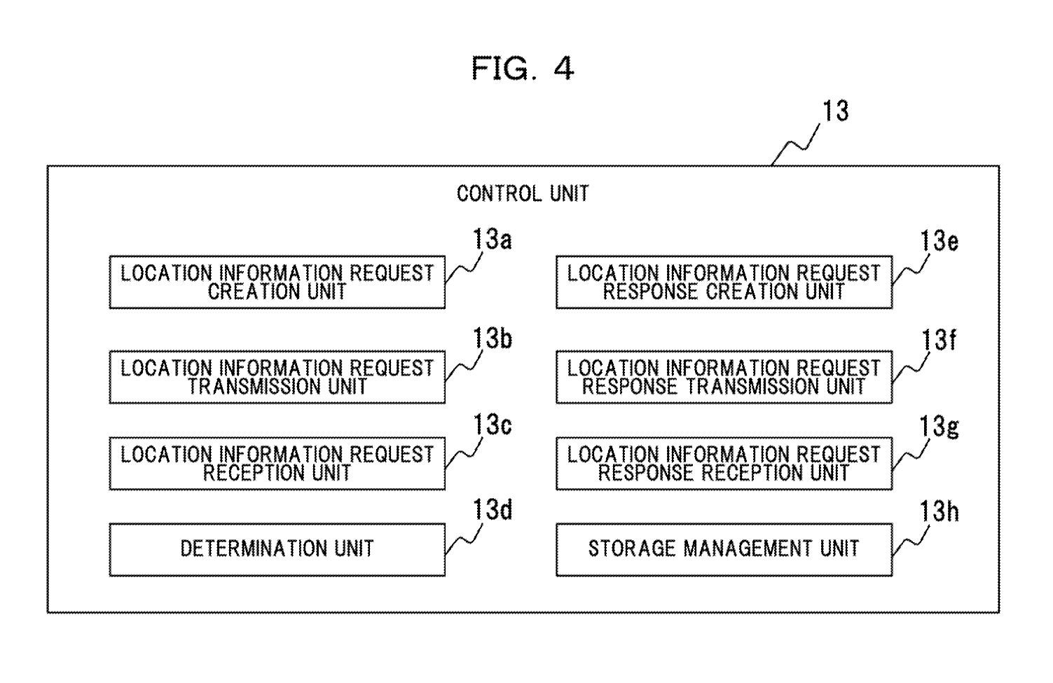

FIG. 4 is a functional block diagram illustrating functions of the control unit 13 in FIG. 3.

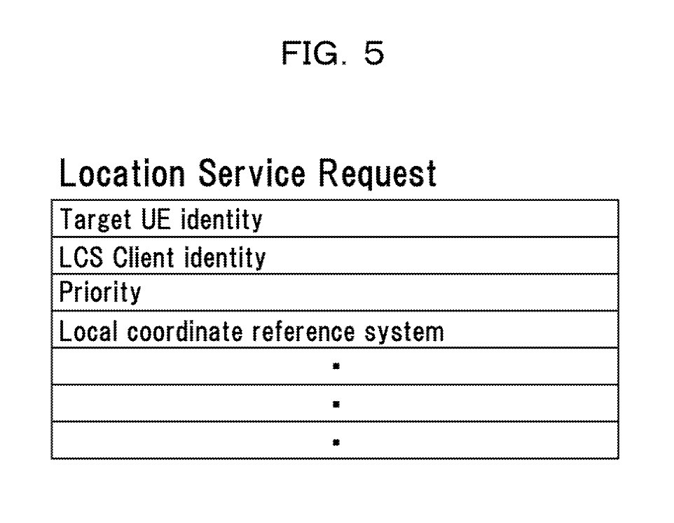

A location information request creation unit 13a creates a signal for requesting another radio communication terminal to provide location information regarding the other radio communication terminal. The signal may be referred to as a location information request. The location information request has, for example, a data structure illustrated in FIG. 5, and includes information regarding the radio communication terminal that is the request destination for provision of location information.

A location information request transmission unit 13b performs control of transmitting the location information request created by the location information request creation unit 13a, to the radio communication terminal that is the request destination for location information.

A location information request reception unit 13c receives a location information request, for requesting the radio communication terminal to provide location information regarding the radio communication terminal, which is transmitted from another radio communication terminal.

When the location information request to the radio communication terminal is received from the other radio communication terminal, a determination unit 13d determines whether or not transfer setting of an incoming call to the radio communication terminal has been performed.

In addition, the determination unit 13d determines whether or not a later-described fixed response setting has been performed.

A location information request response creation unit 13e creates a response to the location information request in accordance with a result of the determination performed by the determination unit 13d. When the determination unit 13d determines that the transfer setting of an incoming call to the radio communication terminal has not been performed, the location information request response creation unit 13e causes location information regarding the radio communication terminal, which is read from the storage unit 14, to be included in the response. On the other hand, when the determination unit 13d determines that the transfer setting of an incoming call to the radio communication terminal has been performed, the location information request response creation unit 13e does not cause the location information regarding the radio communication terminal to be included in the response. Rather, the location information request response creation unit 13e causes the phone number of the transfer destination (transfer destination information) to be included in the response when the determination unit 13d determines the transfer setting have been performed. In other words, when the transfer setting of an incoming call to the radio communication terminal has been performed, the location information request response creation unit 13e performs control of restraining conclusion of the location information regarding the radio communication terminal in the response.

In addition, when the determination unit 13d determines that the fixed response setting has been performed, the location information request response creation unit 13e causes the later-described fixed location information, which is read from the storage unit 14, to be included in the response to the location information request.

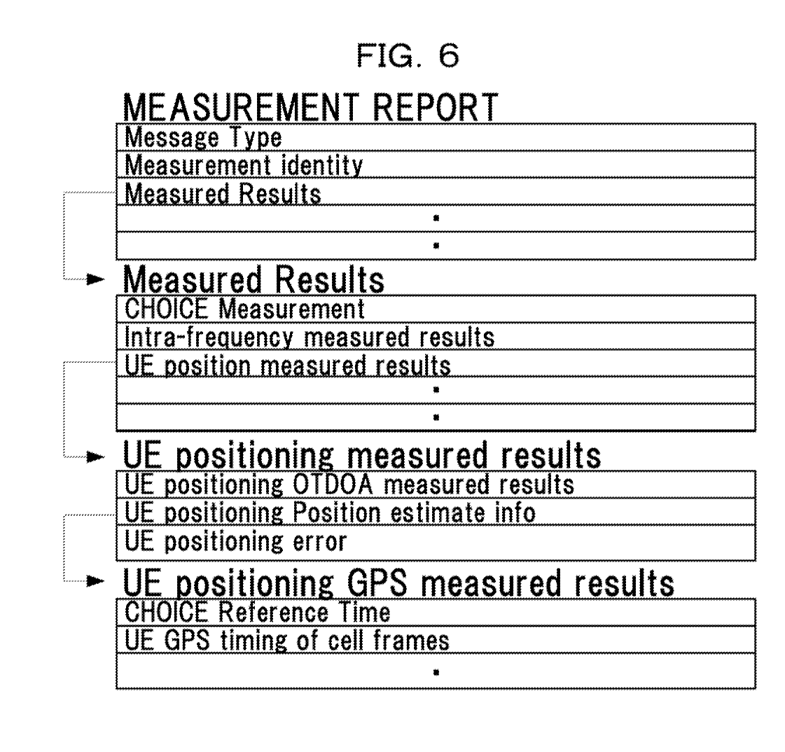

FIG. 6 illustrates an example of a data structure of data included in the response to the location information request. The location information request response creation unit 13e writes the location information regarding the radio communication terminal into each region of a “MEASUREMENT REPORT”. In addition, when not writing the location information regarding the radio communication terminal, the location information request response creation unit 13e writes the transfer destination information or the fixed location information into a “UE GPS timing of cell frames” in a blank region of the “MEASUREMENT REPORT”.

A location information request response transmission unit 13f performs control of transmitting the response created by the location information request response creation unit 13e, to the radio communication terminal that is the request source for location information.

A location information request response reception unit 13g receives a response that is transmitted from another radio communication terminal in accordance with the location information request from the radio communication terminal.

A storage management unit 13h manages reading of information stored in the storage unit 14 and writing of information into the storage unit 14.

### (4) Operation Flow of an Embodiment

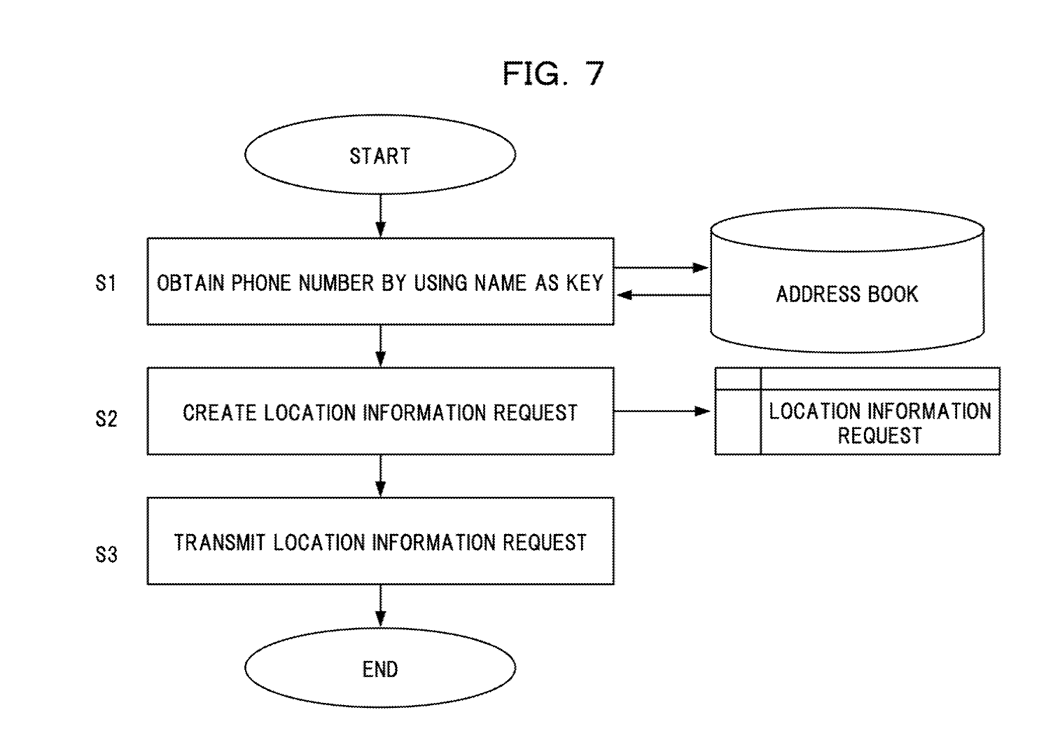

FIGS. 7 to 9 are flow charts for explaining in detail an operation of an embodiment. The following will describe the case of FIG. 2 as an example with reference to the device configuration diagram of FIG. 3.

FIG. 7 illustrates a flow in which the terminal 1-1 creates and transmits a location information request for requesting the terminal 1-2 to provide location information.

In S1, the control unit 13 of the terminal 1-1 obtains a phone number corresponding to the user name of the terminal 1-2. For example the phone number may be obtained by referring to the address book of the storage unit 14 of the terminal 1-1.

In S2, the control unit 13 of the terminal 1-1 creates the location information request by using the phone number obtained at S1.

In S3, the control unit 13 of the terminal 1-1 performs control of transmitting the location information request created at S2, to the terminal 1-2 via the NW 7.

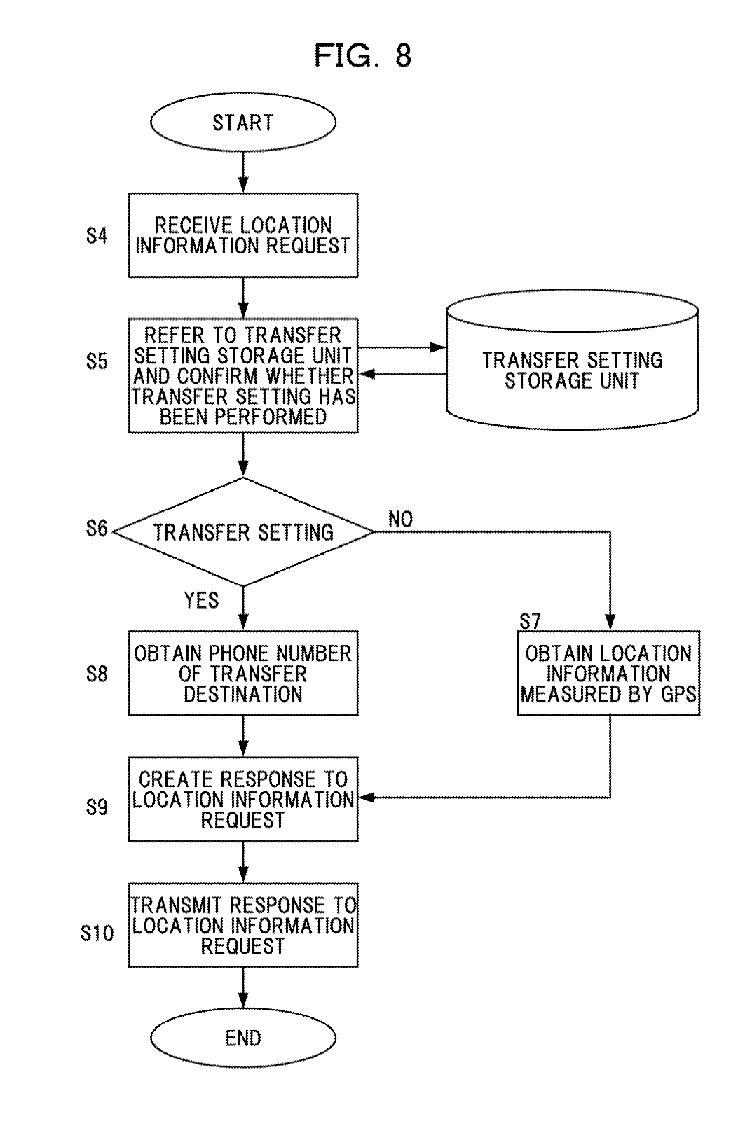

FIG. 8 illustrates a flow in which the terminal 1-2 receives the location information request transmitted from the terminal 1-1 and transmits a response to the location information request.

In S4, the control unit 13 of the terminal 1-2 receives the location information request.

In S5 and S6, the control unit 13 of the terminal 1-2 refers to the transfer setting storage unit of the storage unit 14 and determines whether or not transfer setting of an incoming call to the terminal 1-2 has been performed. This determination is performed, for example, based on presence/absence of a transfer setting flag in the transfer setting storage unit.

In S7, when the control unit 13 of the terminal 1-2 determines that the transfer setting of an incoming call to the terminal 1-2 has not been performed (NO at S6), the GPS unit 12 obtains the location information regarding the terminal 1-2 by positioning or from the network.

In S8, when the control unit 13 of the terminal 1-2 determines that the transfer setting of an incoming call to the terminal 1-2 has been performed (YES at S6), the control unit 13 obtains, from the transfer setting storage unit of the storage unit 14, the phone number of the terminal 1-3 to which the transfer setting has been performed (e.g., a transfer setting flag is attached) and that is the transfer destination.

In S9, the control unit 13 of the terminal 1-2 creates the response to the location information request by using the location information obtained at S7 or the transfer destination information obtained at S8.

In S10, the control unit 13 of the terminal 1-2 performs control of transmitting the response to the location information request, which is created at S9, via the NW 7 to the terminal 1-1 that is the request source of the location information request.

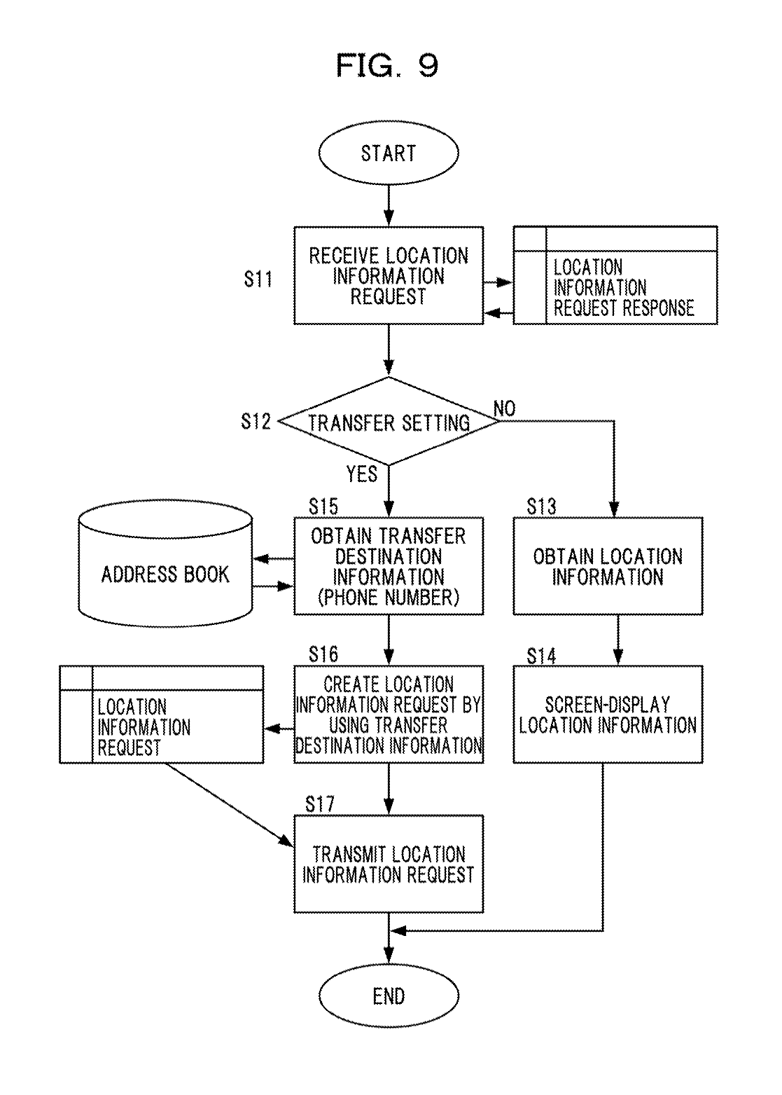

FIG. 9 illustrates a flow in which the terminal 1-1 receives, from the terminal 1-2, the response to the location information request and obtains the location information or the transfer destination information.

In S11, the control unit 13 of the terminal 1-1 receives the response to the location information request.

In S12, the control unit 13 of the terminal 1-1 determines, based on information included in the response received at S11, whether or not transfer setting of an incoming call to the terminal 1-2 has been performed.

In S13, when the location information regarding the terminal 1-2 is included in the response received at S11 (when the transfer destination information is not included), the control unit 13 of the terminal 1-1 determines that the transfer setting of an incoming call to the terminal 1-2 has not been performed, and obtains the location information regarding the terminal 1-2.

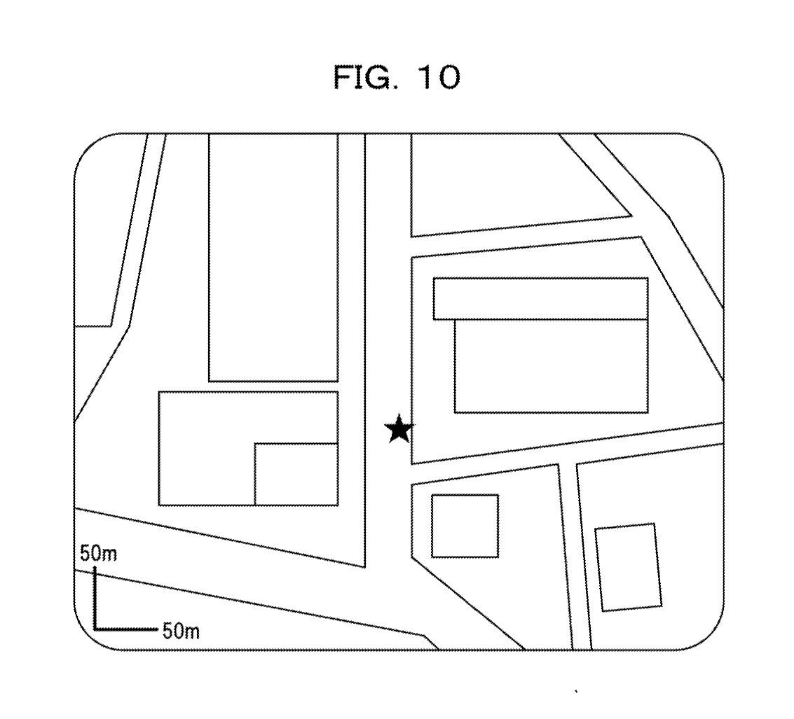

In S14, the control unit 13 of the terminal 1-1 performs control of screen-displaying the location information obtained at S13, on the display unit 15. For example, the display unit 15 displays, on a display thereof, a map in which a location indicated by the obtained location information is marked. FIG. 10 illustrates an example of a screen displayed on the display.

In S15, when the location information regarding the terminal 1-2 is not included in the response received at S11 (when the transfer destination information is included), the control unit 13 of the terminal 1-1 determines that the transfer setting of an incoming call to the terminal 1-2 has been performed, and obtains the transfer destination information that is set in the terminal 1-2.

In addition, in accordance with obtaining of the transfer destination information, the control unit 13 of the terminal 1-1 may perform control of storing, in the address book of the storage unit 14, the user name of the terminal 1-2 and the phone number of the terminal 1-3 that is the transfer destination, which phone number is indicated by the transfer destination information, such that the user name and the phone number are associated with each other.

In S16, the control unit 13 of the terminal 1-1 creates a location information request for requesting the terminal 1-3 to provide location information regarding the terminal 1-3, by using the phone number of the terminal 1-3 that is the transfer destination, which phone number is indicated by the transfer destination information obtained at S15.

In S17, the control unit 13 of the terminal 1-1 performs control of transmitting the location information request created at S16, via the NW 7 to the terminal 1-3 that is the transfer destination for an incoming call to the terminal 1-2.

According to the same flow as in FIG. 8, the terminal 1-3 receives the location information request transmitted from the terminal 1-1, and performs control of transmitting a response to the location information request, to the terminal 1-1. In other words, when transfer setting of an incoming call to the terminal 1-3 has not been performed, the terminal 1-3 causes location information regarding the terminal 1-3 to be included in the response and transmits the response to the terminal 1-1. On the other hand, when the transfer setting of an incoming call to the terminal 1-3 has been performed, the terminal 1-3 does not cause the location information regarding the terminal 1-3 to be included in the response, but instead, causes transfer destination information that is set in the terminal 1-3 to be included in the response and transmits the response to the terminal 1-1.

According to the above, when the transfer setting of an incoming call to the terminal 1-2 has been performed, the terminal 1-1 may obtain the location information regarding the transfer destination, not the location information regarding the terminal 1-2. In other words, for example, when the user of the terminal 1-2 carries the terminal 1-3 that is the transfer destination for an incoming call to the terminal 1-2, the user of the terminal 1-1 may confirm the location of the user of the terminal 1-2 which is the location of the terminal 1-3.

### (5) Operation Flow of a Modified Example of an Embodiment

In a modified example, certain location information that has been previously set in a radio communication terminal, instead of the obtained location information regarding the radio communication terminal in the above embodiment, is caused to be included in the response to the location information request.

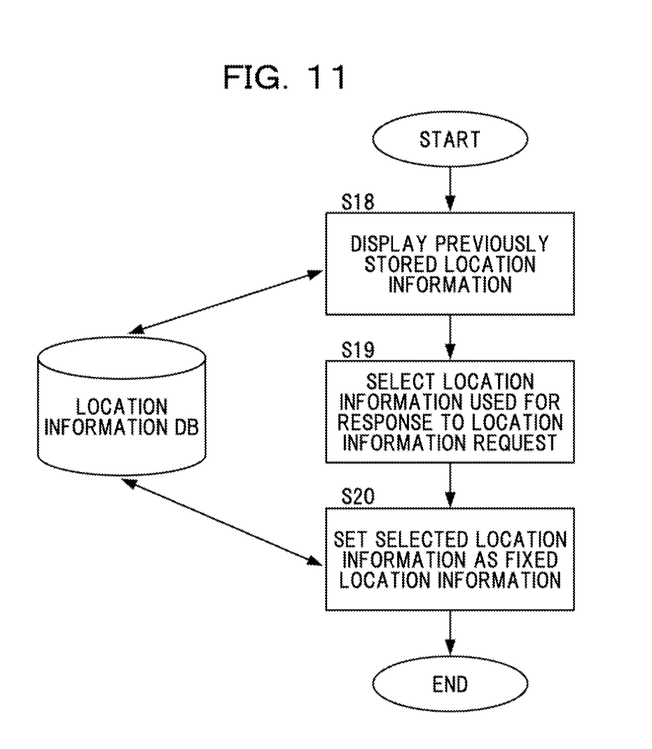

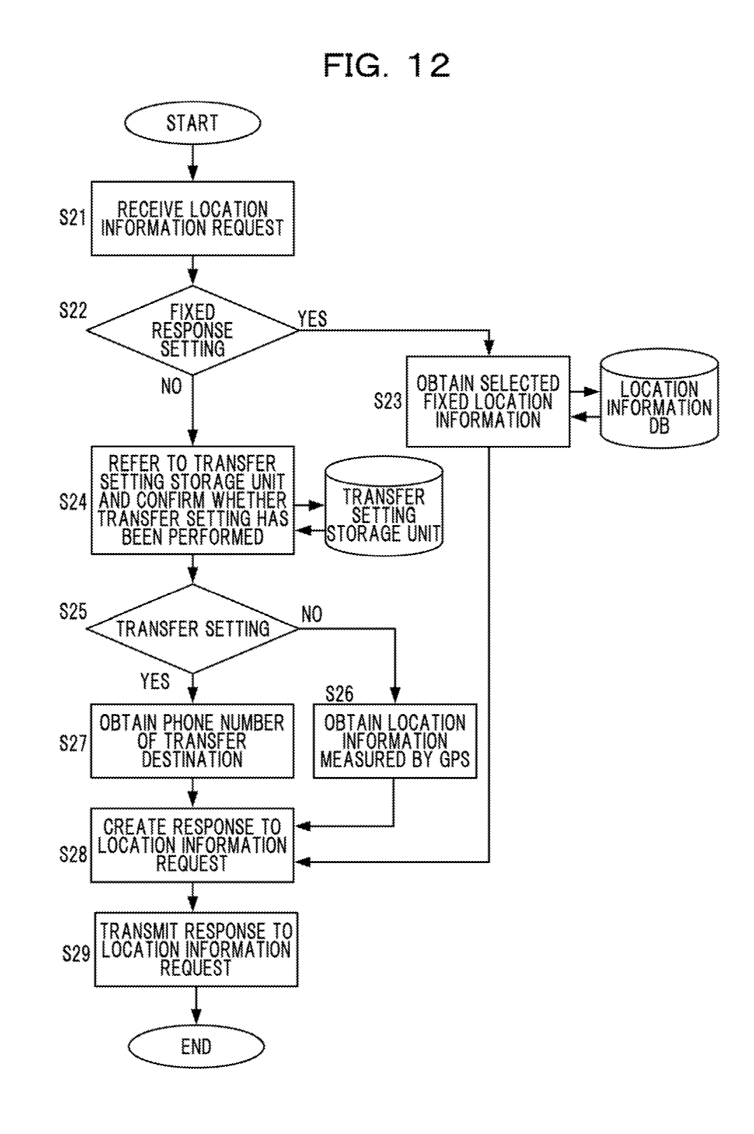

FIGS. 11 and 12 are flow charts for explaining in detail an operation of the modified example. Similarly, as in the above-described embodiment, the case of FIG. 2 will be described as an example with reference to the device configuration diagram of FIG. 3.

First, in the modified example, the location information DB of the storage unit 14 has previously stored one or more pieces of location information that are inputted from an input unit, not illustrated, by the user of the radio communication terminal. Examples of the location information stored in the location information DB include the location of a company to which the user of the radio communication terminal belongs, and location information indicative of the location of the user's home.

FIG. 11 illustrates a flow in which each radio communication terminal selects one piece of location information as location information regarding the radio communication terminal from the location information DB.

In S18, the control unit 13 of each radio communication terminal performs control of screen-displaying, on the display unit 15, one or more pieces of location information that have been previously stored in the location information DB of the storage unit 14.

In S19, an input unit, not illustrated, of each radio communication terminal accepts an input, performed by the user, for selecting one piece of location information from among the one or more pieces of location information that are screen-displayed at S18.

In S20, in accordance with the input at S19, the control unit 13 of each radio communication terminal sets the selected location information as location information regarding the radio communication terminal that is used for a response to a location information request from another radio communication terminal. This setting is performed, for example, by attaching a flag to the location information selected from among the location information stored in the location information DB. Hereinafter, the location information set at S20 is referred to as fixed location information, and the setting in which a location information request from another radio communication terminal is responded to by using the fixed location information is referred to as fixed response setting.

A flow in which the terminal 1-1 creates and transmits a location information request for requesting the terminal 1-2 to provide location information is the same as in FIG. 7, and thus the description thereof is omitted.

FIG. 12 illustrates a flow in which the terminal 1-2 receives a location information request transmitted from the terminal 1-1 and transmits a response to the location information request.

In S21, the control unit 13 of the terminal 1-2 receives the location information request transmitted from the terminal 1-1.

In S22, the control unit 13 of the terminal 1-2 determines whether or not fixed response setting has been performed. This determination is performed, for example, based on whether or not a flag has been attached to any piece of location information stored in the location information DB.

In 23 S23, when determining that the fixed response setting has been performed (YES at S22), the control unit 13 of the terminal 1-2 obtains, from among the location information stored in the location information DB, fixed location information to which a flag for the fixed response setting has been attached.

In S24 and S25, determining that the fixed response setting has not been performed (NO at S22), the control unit 13 of the terminal 1-2 refers to the transfer setting storage unit of the storage unit 14 and determines whether or not transfer setting of an incoming call to the terminal 1-2 has been performed. This determination is performed, for example, based on presence/absence of a transfer setting flag in the transfer setting storage unit.

In S26, when the control unit 13 of the terminal 1-2 determines that the transfer setting of an incoming call to the terminal 1-2 has not been performed (NO at S25), the GPS unit 12 obtains location information regarding the terminal 1-2 by positioning or from the network.

In S27, when the control unit 13 of the terminal 1-2 determines that the transfer setting of an incoming call to the terminal 1-2 has been performed (YES at S25), the control unit 13 obtains, from the transfer setting storage unit of the storage unit 14, the phone number of the terminal 1-3 to which the transfer setting has been performed (e.g., a transfer setting flag is attached) and that is the transfer destination.

In S28, the control unit 13 of the terminal 1-2 creates the response to the location information request by using the fixed location information obtained at S23, the location information obtained at S26, or the transfer destination information obtained at S27.

In S29, the control unit 13 of the terminal 1-2 performs control of transmitting the response to the location information request, which is created at S28, via the NW 7 to the terminal 1-1 that is the request source of the location information request.

Hereinafter, a flow in which the terminal 1-1 receives, from the terminal 1-2, the response to the location information request and obtains the location information or the transfer destination information is the same as in FIG. 9, and thus the description thereof is omitted.

According to the above, the terminal 1-1 may obtain the certain location information that has been previously set in the terminal 1-2, instead of the transfer destination information or the location information regarding the terminal 1-2.

Moreover, when the certain location information has not been previously set in the terminal 1-2 and the transfer setting of an incoming call to the terminal 1-2 has been performed, the terminal 1-1 may obtain the location information regarding the terminal 1-3 that is the transfer destination, rather the location information regarding the terminal 1-2.

Therefore, for example, regardless of whether or not the transfer setting of an incoming call to the terminal 1-2 has been performed, the user of the terminal 1-1 may know a certain location (e.g., the location of the company to which the user of the terminal 1-2 belongs or the location of the home of the user of the terminal 1-2) that is selected by the user of the terminal 1-2.

Moreover, when the transfer setting of an incoming call to the terminal 1-2 has been performed, the terminal 1-1 may obtain the location information regarding the terminal 1-3 that is the transfer destination, not the location information regarding the terminal 1-2. In other words, for example, when the user of the terminal 1-2 carries the terminal 1-3 that is the transfer destination for an incoming call to the terminal 1-2, the user of the terminal 1-1 may confirm the location of the user of the terminal 1-2 which is the location of the terminal 1-3.

### (6) Others

In the above discussion, the case where the terminals 1-1 to 1-3 are radio communication terminals has been described as an example. However, the communication terminal (e.g., the terminal 1-3) that is set as the transfer destination may be a communication terminal (e.g., a fixed-line telephone) that is connected to the fixed communication network.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1. A location information notification method of a communication terminal, the method comprising:
receiving a signal indicating a request for the communication terminal to provide location information;
determining whether a transfer setting for the communication terminal has been performed, the transfer setting indicating that communications to the communication terminal are being transferred to another communication terminal; and
causing a condition restraining transmission of the location information from the communication terminal in response to the received signal when the determining determines the transfer setting has been performed.

2. The location information notification method according to claim 1, wherein at least one of the communication terminal and the another communication terminal is a radio communication terminal.

3. The location information notification method according to claim 1, further comprising:
transmitting the location information from the communication terminal to a source of the received signal when the determining determines that the transfer setting has not been performed.

4. The location information notification method according to claim 1, further comprising:
transmitting transfer destination information from the communication terminal to a source of the received signal when the determining determines that the transfer setting has been performed, the transfer destination information including information regarding the another communication terminal.

5. The location information notification method according to claim 1, further comprising:
performing the setting transfer; and
setting a flag used to indicate that a setting transfer has been performed, wherein
the determining determines the transfer setting has been performed based on the set flag.

6. The location information notification method according to claim 1, further comprising:
storing a response to transmit to a source of the received signal; and
ascertaining whether a fixed response setting of the communication terminal has been performed, the fixed response setting causing the communication terminal to provide the stored response to the source of the received signal.

7. A location information notification method of a communication terminal, the method comprising:
storing certain information for responding to a received signal requesting location information of the communication terminal when a transfer setting has been performed on the communication terminal, the transfer setting causing and indicating that communications to the communication terminal are being transferred to another communication terminal; and
transmitting the certain information to a source of the received signal without transmitting the location information regarding the communication terminal when the transfer setting has been performed on the communication terminal.

8. The location information notification method according to claim 7, wherein at least one of the communication terminal and the another communication terminal is a radio communication terminal.

9. The location information notification method according to claim 7, wherein the certain information has been previously set and is information regarding a transfer destination or certain location information that is different from the location information regarding the communication terminal.

10. A communication terminal comprising:
a receiving unit that receives a signal indicating a request for the communication terminal to provide location information; and
a control unit that
determines whether a transfer setting for the communication terminal has been performed, the transfer setting indicating that communications to the communication terminal are being transferred to another communication terminal, and
causes a condition for restraining transmission of the location information from the communication terminal in response to the received signal when the control unit determines the transfer setting has been performed.

11. The communication terminal according to claim 10, wherein at least one of the communication terminal and the another communication terminal is a radio communication terminal.

12. The communication terminal according to claim 10, further comprising:
a memory storing certain information for responding to the received signal requesting location information of the communication terminal when the transfer setting has been performed on the communication terminal,
wherein the control unit performs control of transmitting the certain information to a source of the received signal without transmitting the location information regarding the communication terminal to the source of the received signal.

13. The communication terminal according to claim 12, wherein the certain information has been previously set and is information regarding a transfer destination or certain location information that is different from the location information regarding the communication terminal.

14. The communication terminal according to claim 10, further comprising:
a transmitting unit that transmits the location information from the communication terminal to a source of the received signal when the control unit determines that the transfer setting has not been performed.

15. The communication terminal according to claim 10, further comprising:
a transmitting unit that transmits transfer destination information from the communication terminal to a source of the received signal when the control unit determines that the transfer setting has been performed, the transfer destination information including information regarding the another communication terminal.

16. The communication terminal according to claim 10, wherein the control unit performs the setting transfer, sets a flag used to indicate that the setting transfer has been performed, and determines the transfer setting has been performed based on the set flag.

17. A location information notification method of a communication terminal, the location information notification method comprising:
transmitting a signal to a first communication terminal to request location information;
receiving transfer destination information from the first communication terminal in response to the transmitted signal, the transfer destination information indicating that communications to the first communication terminal are being transferred to a second communication terminal and including information of the second communication terminal;
transmitting a second signal to the second communication terminal to request the location information;
receiving the requested location information from the second communication terminal; and
displaying the received location information.

18. The location information notification method according to claim 17, further comprising:
associating the requested location information from the second communication terminal with a user associated with the first communication terminal since communications of the first communication terminal are being transferred to the second communication terminal.
